(19) United States
(12) Patent Application Publication
(10) Pub. No.: US 2023/0177386 A1
(43) Pub. Date: Jun. 8, 2023

(54) TRAINING ALGORITHMS FOR ONLINE MACHINE LEARNING

(71) Applicant: International Business Machines Corporation, Armonk, NY (US)

(72) Inventors: Dustin Michael Sargent, San Diego, CA (US); Russell L. Klenk, Julian, CA (US); Sun Young Park, San Diego, CA (US)

(21) Appl. No.: 17/643,016

(22) Filed: Dec. 7, 2021

(51) Int. Cl. G06N 20/00

(52) U.S. Cl. CPC G06N 20/00

(57) ABSTRACT

Currently deployed models are replaced with new models when corresponding deployed algorithms are updated. The updated algorithm is pre-trained offline on training data used by the currently deployed model. Concurrent deployment of the pre-trained model during operation of the currently deployed model within the same AI system provides secondary training of the pre-trained model. For the same input, output of the currently deployed model is compared to output of the pre-trained model and a decreasing rewards process encourages matching output to that of the currently deployed model until a condition is met. Upon meeting the condition, the pre-trained model become the currently deployed model and the previously deployed model is no longer in use.

### BACKGROUND

The present invention relates generally to the field of online machine learning, and more particularly to the training of updated reinforcement learning algorithms.

Machine learning is a form of artificial intelligence that enables a system to learn from data rather than through explicit programming. As machine learning algorithms ingest training data, it is possible to produce machine learning models based on the training data. A machine learning model is the output generated by a machine learning algorithm trained with data. After training the algorithm, a generated model may be given an input from which output is provided. For example, a predictive algorithm will create a predictive model. When the predictive model is provided with data, a prediction is output based on the data that trained the algorithm on which the model is based.

Online machine learning is a method of machine learning in which data becomes available in a sequential order. New data is used to update the best predictor for future data at each step. This varies from offline machine learning techniques where the best predictor is generated by learning on an entire training data set all at once.

Online machine learning is often used where it is computationally infeasible to learn, or train, over the entire dataset. Oftentimes, when it is infeasible to train over the entire dataset, there is a need to use out-of-core algorithms, or external memory algorithms, to perform the learning. Online learning may also be used in situations where it is necessary for the algorithm to dynamically adapt to new patterns in the data or when the data itself is generated as a function of time.

Reinforcement learning is an area of machine learning concerned with how intelligent agents ought to take actions in an environment in order to maximize the notion of cumulative reward. The purpose of reinforcement learning is for the algorithm to learn an optimal policy that maximizes the reward function that accumulates from the immediate rewards.

### SUMMARY

In one aspect of the present invention, a method, a computer program product, and a system includes: (i) identifying an updated algorithm related to a current algorithm, the current algorithm deployed in an online machine learning environment and the updated algorithm having revised terms with respect to the current algorithm; (ii) training the updated algorithm with training data used by the current algorithm; (iii) deploying an updated model generated by the trained updated algorithm in an artificial intelligence system in which a current model generated by the current algorithm is operating; and (iv) transferring learning of the current model to the updated model by comparing output from the updated model to output of the current model responsive to the same input.

In another aspect of the present invention, a method, a computer program product, and a system includes: (i) storing input and output pairs P (P1, P2, ..., Pn) for the deployed algorithm; (ii) associating rewards R (R1, R2, ..., Rn) with the input and output pairs P (P1, P2, ..., Pn); (iii) selecting a subset of the input output pairs P′ (P′1, P′2, ..., P′n) from the input and output pairs P (P1, P2, ..., Pn) wiith rewards R′ (R′l, R′2, ..., R′k) deemed significant from the rewards R (R1, R2, ..., Rn); and (iv) performing supervised training of the new algorithm using the selected subset input output pairs P′ (P′1, P′2, ..., P’n).

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is block diagram view of a second embodiment of a system according to the present invention.

### DETAILED DESCRIPTION

Currently deployed models are replaced with new models when corresponding deployed algorithms are updated. The updated algorithm is pre-trained offline on training data used by the currently deployed model. Concurrent deployment of the pre-trained model during operation of the currently deployed model within the same AI system provides secondary training of the pre-trained model. For the same input, output of the currently deployed model is compared to output of the pre-trained model and a decreasing rewards process encourages matching output to that of the currently deployed model until a condition is met. Upon meeting the condition, the pre-trained model become the currently deployed model and the previously deployed model is no longer in use. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer, or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

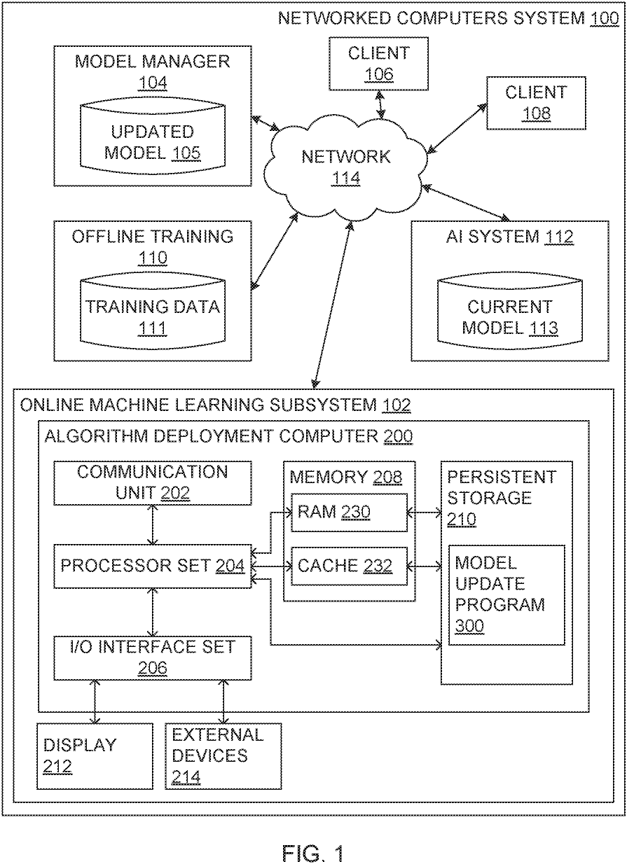

The present invention will now be described in detail with reference to the Figures. FIG. 1 is a functional block diagram illustrating various portions of networked computers system 100, in accordance with one embodiment of the present invention, including: online machine learning sub-system 102; model manager sub-system 104; updated model store 105; client sub-systems 106, 108; offline training sub-system 110; training data store 111; artificial intelligence sub-system 112; current model store 113; communication network 114; algorithm deployment computer 200; communication unit 202; processor set 204; input/output (I/O) interface set 206; memory device 208; persistent storage device 210; display device 212; external device set 214; random access memory (RAM) devices 230; cache memory device 232; and machine learning model update program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Model update program 300 operates to update current algorithms via offline training of updated algorithms based on knowledge obtained by current algorithms. In that way, the updated algorithm is trained using the currently deployed algorithm on which the current model is based. Knowledge transfer from the current model to an updated model is performed using modified reward function processing with gradually reducing probability until the current model is deleted according to a given set of conditions on the updated model.

The term updated algorithm as used herein is used to distinguish a new algorithm from a currently deployed algorithm. The updated algorithm does not have to be entirely new, but according to some embodiments of the present invention, the “updated algorithm” could actually be an entirely new algorithm. The reference to an updated algorithm could refer to anything from a small change of the existing algorithm to a totally new algorithm. For example, if the current algorithm is a neural network, it could be a small change to the network architecture, or it could be a change to a totally different type of algorithm (like a Q-learning table), as long as the updated algorithm can be trained by the same type of data as the neural network.

Some embodiments of the present invention recognize the following facts, potential problems and/or potential areas for improvement with respect to the current state of the art: (i) deploying updates to machine learning algorithms should involve minimal or no downtime; (ii) deploying updates to machine learning algorithms should ensure that accuracy is maintained or improved after the update; (iii) deploying a new model risks losing accumulated online learning progress; (iv) conventional training is performed when a totally new reinforcement learning algorithm is being deployed; and/or (v) conventionally, transfer learning with labeled data does not apply to reinforcement learning.

Some embodiments of the present invention are directed to accelerating the process of bringing a new algorithm up to the performance level of a current algorithm in an online learning algorithm environment. Further, an online training method facilitates smooth transition from a current model to a new model according to update of the underlying current algorithm. Introducing a modified reward function for knowledge transfer from the current model to the new, or updated, model, ensures the accuracy of the updated model upon completing the transition.

Some embodiments of the present invention are directed to training an updated algorithm in a process including: (i) pre-training of the updated algorithm using the currently deployed algorithm; (ii) using modified reward functions to ensure accuracy of the knowledge transfer from the current model to the updated model; and (iii) using current algorithm to perform actions with gradually reduced probability.

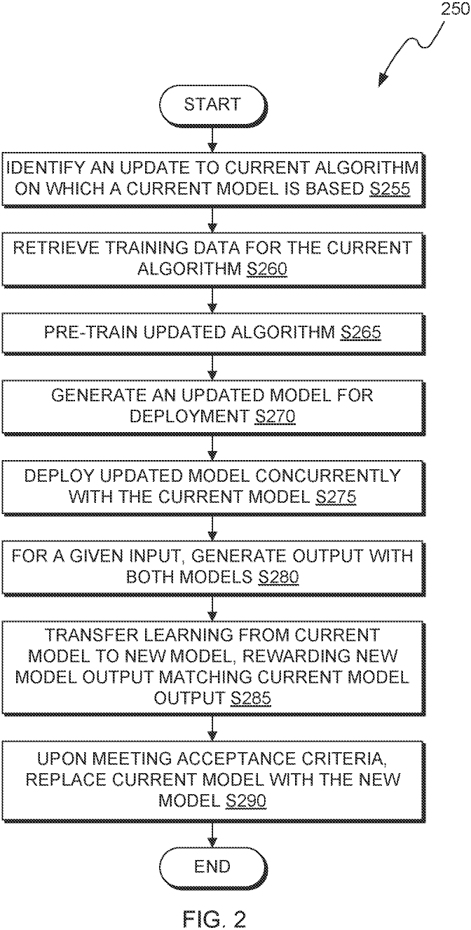

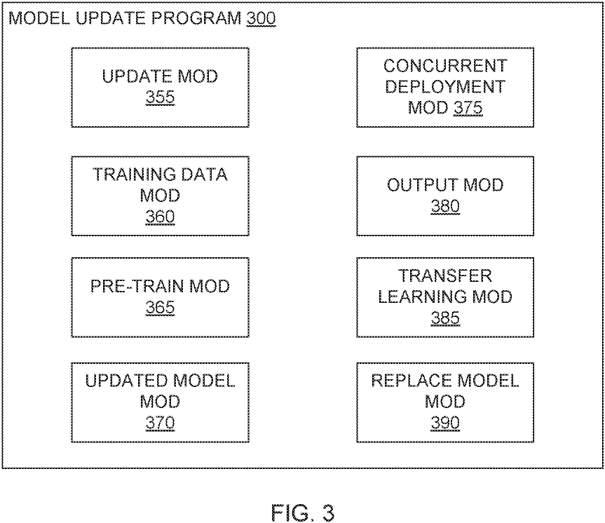

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where update module (“mod”) 355 identifies an update to a current algorithm on which a current model is based. In this discussion, models are generated by algorithms trained on a set of training data. The models are deployed for online use in taking an action based on an inference, which is based on the training data processed by the corresponding algorithm. In this example, model manager sub-system 104 notifies update mod 355 of updated model 105 corresponding to current model 113, which is in use by artificial intelligence sub-system 112 (FIG. 1). Alternatively, the update module monitors a service for an update to the current algorithm. Alternatively, a user prompts the update module to identify the update.

Processing proceeds to step S260, where training data mod 360 retrieves training data for the current algorithm. During deployment of the current model, sets of input/output pairs are generated and stored for future reference to improve and maintain accuracy. In this example, the training data is stored in training data store 111 (FIG. 1) during use of the current model. This training data is retrieved for use in training the updated algorithm identified in step S255.

Processing proceeds to step S265, where pre-train mod 365 pre-trains the updated algorithm. Pre-training is performed on the updated algorithm prior to deployment by using existing training data generated for use by the current algorithm and corresponding model. By pre-training the updated algorithm certain ground truths of the current algorithm are learned by the updated algorithm, leading to a more consistent set of actions being taken by the current and the new, or updated, models.

Processing proceeds to step S270, where updated model mod 370 generates an updated model for deployment. The updated algorithm, having been training on training data referenced by the deployed, or current, model generates an updated model for deployment in the AI system using the current model. The updated model will be further training while in use alongside the current model.

Processing proceeds to step S275, where concurrent deployment mod 375 deploys the updated model concurrently with the current model being in-use with the same AI system. In this example, AI sub-system 112 receives input over network 114 for receipt by updated model 105 and current model 113. Both models operate concurrently to improve knowledge transfer from the current model to the updated model.

Processing proceeds to step S280, where output mod 380, for a given input, generates output with both models, the updated model and the current model. Having been pre-trained on the training dataset of the current model, the updated model is prepared to take actions or make inferences on given inputs similar to how the current model operates. In this way, the updated model participates in online training, taking learning actions in view of the inferences or actions of the current model.

Processing proceeds to step S285, where transfer learning mod 385 transfers learning from the current model to the new model, rewarding new-model output that matches current-model output. The transfer learning process involves rewards for input/output pairs generated by the updated model that match input/output pairs of the current model. In some embodiments of the present invention, inputs and outputs are stored for the current model and rewards are associated with the various input/output pairs. The more significant input/output pairs are assigned higher rewards. During supervised training of the updated model, the reward system guides the updated model to respond similar to the current model. In this example, the rewards are variable, decreasing with the variable probability of choosing outputs from the current model from initially favoring the matching output until the probability is reduced to zero.

Processing ends at step S290, where replace mod 390, upon meeting acceptance criteria, replaces the current model with the new model. When the pre-training and subsequent online training of the new model based on the updated algorithm is completed, the new model replaces the current model so that only one model processes input instead of the concurrent processing established at step S375. In this example, updated model 105 replaces current model 113 in AI sub-system 112 (FIG. 1).

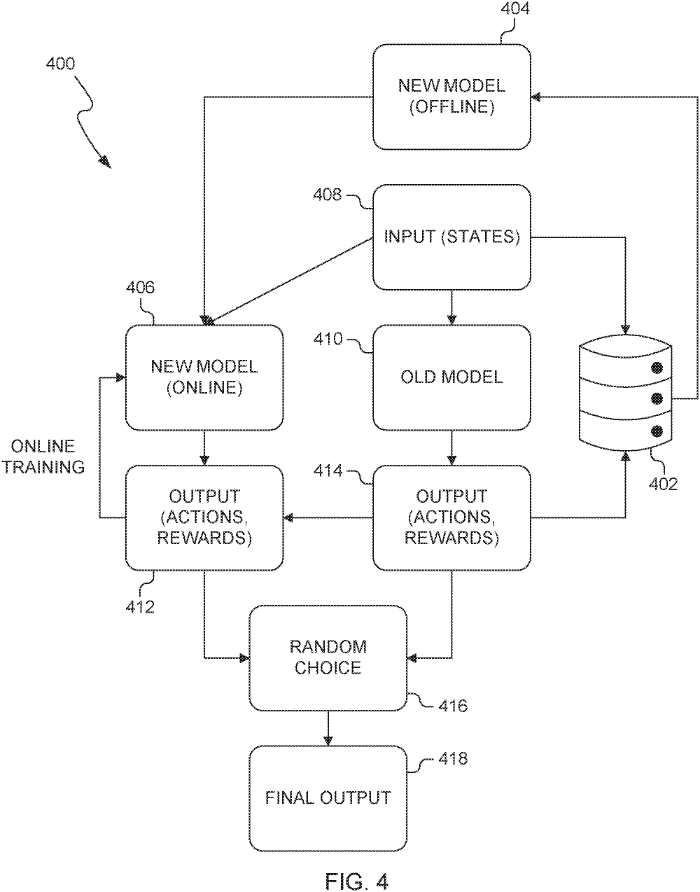

Further embodiments of the present invention are discussed in the paragraphs that follow and with reference to FIG. 4.

The method described herein applies if one or both of the related algorithms, current and new/updated, are deep-learning-based algorithms. That is, one of the algorithms may be based on a Q-learning lookup table.

FIG. 4 shows system 400 for performing method steps performing operations according to various embodiments of the present invention. Example software and corresponding system components will now be discussed, over the course of the following paragraphs, with reference to FIG. 4. A program performing operations described below may be implemented in a networked computers system such as program 300 of networked computers system 100 (FIG. 1).

According to some embodiments of the present invention, old model 410 is used to choose actions 414 based on inputs (states) 408. The set of inputs, the actions chosen by the old model, and rewards received for the actions are saved to training data store 402. The collected data is filtered to identify “state/action” pairs that received rewards above a threshold level of reward. The actions taken by the old model are considered as ground truth labels.

New model 404 is trained according to a supervised training process using the filtered state/action pairs. The state/action pairs may also be referred to as “input/label” pairs.

The new model is deployed while maintaining deployment of old model 410. Upon deployment of the new model online 406, inputs are presented to the two models for an inference action. For inferences 412 of the new model that agree with inferences 414 of the old model, a reward function grants bonus positive rewards. The online training process applies only to the new model. Over time, as the new model is trained with the rewards function, the bonus is tapered down until a bonus level indicated removal of the old model. For example, a threshold bonus level is specified below which the old model is removed.

During the training process for the new model, actions 416 are taken by the old model with a probability epsilon to generate a final output model 418.

Some embodiments of the present invention are directed to deploying algorithm updates for reinforcement learning with reference to architecture changes and not having any training data.

Some embodiments of the present invention involve model deployment in such a way as to deal with more than model drift that primarily applies to supervised learning.

Some embodiments of the present invention are directed to a method for reinforcement learning algorithms that can be applied when models typically learn from trial-and-error exploration.

Some embodiments of the present invention may include one, or more, of the following features, characteristics and/or advantages: (i) addresses challenges of supervised learning associated with the differences between real data and offline training data; (ii) overcomes challenges of supervised learning associated with changes or updates to algorithms; (iii) addresses the challenge of supervised deep learning associated with changes in model architecture preventing simple weight updates; (iv) resolves the additional challenge of online learning algorithms in that online learning algorithms cannot be trained offline; (v) facilitates smooth transition from a current algorithm to a new, updated algorithm; (vi) automatically generates offline training data using a deployed reinforcement learning algorithm; (vii) the deployed reinforcement learning algorithm guides the early training phase of the new algorithm; (viii) applies to situations in which there is already a reinforcement learning algorithm deployed and the deployed algorithm is being upgraded; (ix) does not require offline models for updated algorithm training; and/or (x) applies transfer learning to train the updated reward-based reinforcement learning algorithm offline and through online guidance of the deployed reinforcement learning algorithm.

Some embodiments of the present invention may include one, or more, of the following features, characteristics and/or advantages: (i) applies to continuous reinforcement learning environments; (ii) applies reinforcement learning algorithms to train online models instead of trial-and-error exploration learning; (iii) applies to the online continuous learning scenario based on exploration without labels; (iv) generates its pre-training data using a deployed algorithm in a live deployment environment; and/or (v) applies transfer learning to train the new model offline and through online guidance.

Some embodiments of the present invention are directed to a method for accelerating online training in the deployment of reinforcement learning algorithm updates, the method including: gathering training data using the currently deployed algorithm, performing offline supervised pre-training of the new algorithm using the gathered data, deploying the pre-trained new algorithm alongside the current algorithm, performing online transfer learning from the current algorithm to the new algorithm, and eventually replacing the current algorithm with the new algorithm.

Some embodiments of the present invention are directed to offline supervised pre-training including: storing a set of [input (state), output (action)] pairs processed by the current algorithm during online use; storing the set of rewards associated with the (state, action) pairs; selecting a subset of the (state, action) pairs associated with significant rewards; and performing supervised training of the new algorithm using the subset of (state, action) pairs as inputs and labels.

Some embodiments of the present invention are directed to online transfer learning including: performing inference on input data using the current and new algorithms; randomly choosing between the outputs of the current and new algorithms with a probability that initially favors the current algorithm; adding a bonus reward for agreeing with the current algorithm if the new algorithm’s output is chosen; gradually reducing the probability of choosing the current algorithm’s output and the amount of the bonus reward; and replacing the current algorithm with the new algorithm when the probability reaches zero.

Some embodiments of the present invention are directed to a method for facilitating deploying a new algorithm while executing a deployed algorithm utilizing a reinforcement learning algorithm including: receiving training data for the deployed algorithm; performing offline supervised pre-training of the new algorithm utilizing the received training data; deploying the pre-trained new algorithm concurrently with the deployed algorithm; transferring learning iteratively from the deployed algorithm to the pre-trained new algorithm until an acceptance criteria is met to form an accepted new algorithm; and deploying the accepted new algorithm.

According to some embodiments of the present invention, the above-mentioned algorithm is an artificial intelligence machine learning model.

Some embodiments of the present invention are directed to transferring learning that includes: storing input and output pairs P (P1, P2, ..., Pn) for the deployed algorithm; associating rewards R (R1, R2, ..., Rn) with the input and output pairs P (P1, P2, ..., Pn); selecting a subset of the input output pairs P′ (P′1, P′2, ..., P′n) from the input and output pairs P (P1, P2, ..., Pn) with rewards R′ (R′1, R′2, ..., R′k) deemed significant from the rewards R (R1, R2, ..., Rn); and performing supervised training of the new algorithm using the selected subset input output pairs P′ (P′1, P′2, ..., P′n).

According to some embodiments of the present invention, the above-mentioned input and output pairs P (P1, P2, ..., Pn) are state and action pairs wherein the state is used as input and the action is used as output and label.

Some embodiments of the present invention are directed to an iterative transferring learning that includes choosing between new algorithm outputs and deployed algorithm outputs iteratively with a variable probability of choosing outputs and a variable bonus reward wherein the variable probability of choosing outputs decreases from initially favoring the deployed algorithm and the variable bonus reward decreases from initially favoring a new algorithm output matching the deployed algorithm output until the variable probability is reduced to zero.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

and/or: inclusive or; for example, A, B “and/or” C means that at least one of A or B or C is true and applicable.

User / subscriber: includes, but is not necessarily limited to, the following: (i) a single individual human; (ii) an artificial intelligence entity with sufficient intelligence to act as a user or subscriber; and/or (iii) a group of related users or subscribers.

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for training updated algorithms in an online machine learning environment, the method comprising:
identifying an updated algorithm related to a current algorithm, the current algorithm deployed in an online machine learning environment and the updated algorithm having revised terms with respect to the current algorithm;
training the updated algorithm with training data used by the current algorithm;
deploying an updated model generated by the trained updated algorithm in an artificial intelligence system in which a current model generated by the current algorithm is operating; and
transferring learning of the current model to the updated model by comparing output from the updated model to output of the current model responsive to the same input.

2. The method of claim 1, wherein transferring learning of the current model includes:
storing a set of input/output pairs for the current model;
associating rewards with each of the input/output pairs;
selecting a sub-set of input/output pairs according to significance of the associated rewards; and
performing supervised learning of the updated model using the selected sub-set of input/output pairs.

3. The method of claim 2, wherein the input/output pairs are state and action pairs, the state used as input and the action used as output and label.

4. The method of claim 1, further comprising:
determining an update to the current algorithm is available as the updated algorithm; and
retrieving the training data used by the current algorithm.

5. The method of claim 1, wherein comparing output includes:
choosing between a first output of the updated model and a second output of the current model according to a variable probability scheme where the current model output is initially favored over the updated model output with decreasing favor over time.

6. The method of claim 5, wherein choosing between a first output of the updated model and a second output of the current model is further according to a variable bonus reward scheme where the updated model output matching the current model output is rewarded with decreasing reward over time.

7. A computer program product comprising a computer-readable storage medium having a set of instructions stored therein which, when executed by a processor, causes the processor to train updated algorithms in an online machine learning environment by:
identifying an updated algorithm related to a current algorithm, the current algorithm deployed in an online machine learning environment and the updated algorithm having revised terms with respect to the current algorithm;
training the updated algorithm with training data used by the current algorithm;
deploying an updated model generated by the trained updated algorithm in an artificial intelligence system in which a current model generated by the current algorithm is operating; and
transferring learning of the current model to the updated model by comparing output from the updated model to output of the current model responsive to the same input.

8. The computer program product of claim 7, wherein transferring learning of the current model includes:
storing a set of input/output pairs for the current model;
associating rewards with each of the input/output pairs;
selecting a sub-set of input/output pairs according to significance of the associated rewards; and
performing supervised learning of the updated model using the selected sub-set of input/output pairs.

9. The computer program product of claim 8, wherein the input/output pairs are state and action pairs, the state used as input and the action used as output and label.

10. The computer program product of claim 7, further comprising:
determining an update to the current algorithm is available as the updated algorithm; and
retrieving the training data used by the current algorithm.

11. The computer program product of claim 7, wherein comparing output includes:
choosing between a first output of the updated model and a second output of the current model according to a variable probability scheme where the current model output is initially favored over the updated model output with decreasing favor over time.

12. The computer program product of claim 11, wherein choosing between a first output of the updated model and a second output of the current model is further according to a variable bonus reward scheme where the updated model output matching the current model output is rewarded with decreasing reward over time.

13. A computer system for training updated algorithms in an online machine learning environment, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to train updated algorithms in an online machine learning environment by:
identifying an updated algorithm related to a current algorithm, the current algorithm deployed in an online machine learning environment and the updated algorithm having revised terms with respect to the current algorithm;
training the updated algorithm with training data used by the current algorithm;
deploying an updated model generated by the trained updated algorithm in an artificial intelligence system in which a current model generated by the current algorithm is operating; and
transferring learning of the current model to the updated model by comparing output from the updated model to output of the current model responsive to the same input.

14. The computer system of claim 13, wherein transferring learning of the current model includes:
storing a set of input/output pairs for the current model;
associating rewards with each of the input/output pairs;
selecting a sub-set of input/output pairs according to significance of the associated rewards; and
performing supervised learning of the updated model using the selected sub-set of input/output pairs.

15. The computer system of claim 14, wherein the input/output pairs are state and action pairs, the state used as input and the action used as output and label.

16. The computer system of claim 13, further comprising:
determining an update to the current algorithm is available as the updated algorithm; and
retrieving the training data used by the current algorithm.

17. The computer system of claim 13, wherein comparing output includes:
choosing between a first output of the updated model and a second output of the current model according to a variable probability scheme where the current model output is initially favored over the updated model output with decreasing favor over time.

18. The computer system of claim 17, wherein choosing between a first output of the updated model and a second output of the current model is further according to a variable bonus reward scheme where the updated model output matching the current model output is rewarded with decreasing reward over time.

19. A computer-implemented method for facilitating deploying a new algorithm while executing a deployed algorithm utilizing a reinforcement learning algorithm comprising:
receiving training data for the deployed algorithm;
performing offline supervised pre-training of the new algorithm utilizing the received training data;
deploying the pre-trained new algorithm concurrently with the deployed algorithm;
transferring learning iteratively from the deployed algorithm to the pre-trained new algorithm until an acceptance criteria is met to form an accepted new algorithm; and
deploying the accepted new algorithm.

20. The computer-implemented method of claim 19, wherein the transferring learning further comprises:
storing input and output pairs P (P1, P2, ..., Pn) for the deployed algorithm;
associating rewards R (R1, R2, ..., Rn) with the input and output pairs P (P1, P2, ..., Pn);
selecting a subset of the input output pairs P′ (P′1, P′2, ..., P′n) from the input and output pairs P (P1, P2, ..., Pn) wiith rewards R′ (R′1, R′2, ..., R′k) deemed significant from the rewards R (R1, R2, ..., Rn); and
performing supervised training of the new algorithm using the selected subset input output pairs P′ (P′1, P′2, ..., P′n).

21. The computer-implemented method of claim 20, wherein the input and output pairs P (P1, P2, ..., Pn) are state an action pairs wherein the state used as input and the action is used as output and label.

22. The computer-implemented method of claim 19, wherein the iterative transferring learning further comprises:
choosing between new algorithm outputs and deployed algorithm outputs iteratively with a variable probability of choosing outputs and a variable bonus reward wherein the variable probability of choosing outputs decreases from initially favoring the deployed algorithm and the variable bonus reward decreases from initially favoring a new algorithm output matching the deployed algorithm output until the variable probability is reduced to zero.

23. The computer-implemented method of claim 19, wherein the deployed algorithm is an artificial intelligence model.
